(19) United States
(12) Patent Application Publication
(10) Pub. No.: US 2003/0023721 A1
(43) Pub. Date: Jan. 30, 2003

(54) Method and apparatus for generating context-descriptive messages

(75) Inventor: Anders Vinberg, Plandome Manor, NY (US)

Correspondence Address: Calfee, Halter & Griswold LLP, 1650 Fifth Third Center, 21 East State Street, Columbus, OH, 43215-4243, US

(73) Assignee: COMPUTER ASSOCIATES THINK, INC.

(21) Appl. No.: 10/091,065

(22) Filed: Mar. 4, 2002

Related U.S. Application Data
(63) Continuation-in-part of application No. 09/949,101, filed on Sep. 7, 2001.
Application No. 09/949,101 is a continuation of application No. 09/408,213, filed on Sep. 27, 1999, now Pat. No. 6,289,380.
Application No. 09/408,213 is a continuation of application No. 08/892,919, filed on Jul. 15, 1997, now Pat. No. 5,958,012.
(60) Provisional application No. 60/272,971, filed on Mar. 2, 2001.

(51) Int. Cl. G06F 15/173; G09G 5/00

(52) U.S. Cl. 709/224; 345/736; 345/737

(57) ABSTRACT

A method for reporting the context of an alert condition is disclosed which includes reporting an alert condition associated with a subject system object, and analyzing one or more system objects associated with the alert condition to obtain context data. The method further includes generating a context message based on the context data, and outputting the context message.

### RELATED APPLICATIONS

This application is a Continuation-In-Part of U.S. Ser. No. 09/949,101 filed Sep. 7, 2001, which is a Continuation of U.S. Pat. No. 6,289,380 issued Sep. 11, 2001, which is a Continuation of U.S. Pat. No. 5,958,012 issued Sep. 28, 1999. This application claims priority to U.S. Provisional Application Serial No. 60/272,971 filed Mar. 2, 2001. The present application incorporates each related application by reference in its entirety.

### TECHNICAL FIELD

The present application generally relates to the field of monitoring and managing ongoing processes. More specifically, the present application relates to systems and methods for generating alert and diagnostic messages which provide a contextual description.

### BACKGROUND

Systems that manage computer or network systems, or other systems with embedded computer technology, commonly monitor various system parameters for the purpose of detecting problems and alerting a human to the problem. Various techniques can be employed to monitor ongoing processes. The monitored values can be analyzed in various ways, including comparison with thresholds, correlation of several values, and correlation of values over time to discover problems, unprecedented situations, or other events. Some systems use various techniques to predict events before they occur. One such system is described in commonly owned U.S. Pat. No. 6,327,550, which is incorporated herein in its entirety by reference. In such systems one response to the discovery or prediction is to bring the event to the attention of a human operator. For example, these management systems can issue a text message alert and different techniques may be employed for presenting this text message to the operator, such as a Windows dialog box, monitoring consoles, event logs, email messages, pager messages. The alert can also be a provided as an audio message through loudspeakers, headsets, or a telephone. An example of a system that provides audio alert messaging is described in commonly owned, concurrently filed, co-pending U.S. Utility Application entitled “Method and Apparatus for Generating and Recognizing Speech as a User Interface Element in Systems and Network Management”, the entirety of which is incorporated herein by reference. Commonly owned, concurrently filed, co-pending U.S. Utility Application entitled “Method And Apparatus For Filtering Messages Based on Context” is also incorporated by reference in its entirety.

The generated alert notification may describe the detected or predicted alert condition in broad terms or in detail. In large management systems with many managed components, the particular component involved in the alert condition is usually identified by name. Typical alert notifications, for example, might look like this:

“uschdb02 has excessive page swapping.”

“Oracle12 journaling drive is full.”

“Coolant temperature of engine 3 is too high.”

“Inventory level of chocolate cookies is low.”

Some management systems also have access to extensive information about managed components, including hardware configurations, software configurations, performance and load, schedules, users, running processes, and network connectivity. Such information may be useful for detecting the cause of an alert condition and identifying a way to avert it or prevent future occurrences. Such information may also be useful for detecting which components are affected, directly or indirectly, by the problem. Such root cause analysis and impact analysis may be aided by automated tools, or may simply be left to a human operator.

In some management systems, a human operator that receives an alert notification about a detected or predicted problem can retrieve information about relevant objects through various types of user interfaces. However, as managed systems get larger, with increasing numbers of components, it is increasingly difficult for a human operator to remember the names of various components, or their functions in the system. Therefore, the original alert notification may be of limited use, and the operator may have to start by searching for an identified component through a graphical user interface, bringing up relevant information from a number of sources, and analyzing the true meaning of the alert.

In addition, since the alert notification typically contains information primarily regarding the alert condition, and limited information about the managed component, the user may often navigate through several layers of user interface to find any potentially useful supporting information. Such current practices are inefficient, and rely on unduly high levels of operator expertise. Since such user interfaces for information retrieval are based on visual metaphors, the requirement to bring up additional information largely negates the benefits of new delivery mechanisms such as pagers and telephone delivery of speech. Although retrieval of information can work over such channels, through keypad entry or speech recognition, when additional information is desirable, such information retrieval mechanisms may be inconvenient.

### SUMMARY OF THE INVENTION

The present disclosure provides management systems and methods with improved alert messaging. The present disclosure also provides alert systems and methods capable of providing a description of the context of an alert notification conditions detected by management systems. According to one embodiment, a method for reporting the context of an alert condition is disclosed which includes reporting an alert condition associated with a subject system object, analyzing one or more system objects associated with the alert condition to obtain context data and generating a context message based on the context data. The method further includes outputting the context message.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1A illustrates an exemplary enterprise system;

FIG. 1B illustrates an exemplary management system topology that may be employed in accordance with the disclosed methodology;

FIG. 2 is a block diagram illustrating exemplary components for implementing one embodiment of an alert system methodology according to the present disclosure; and

FIG. 3 is an exemplary flow diagram of one method for reporting the context associated with an alert condition in accordance with one embodiment of the present disclosure.

### DETAILED DESCRIPTION

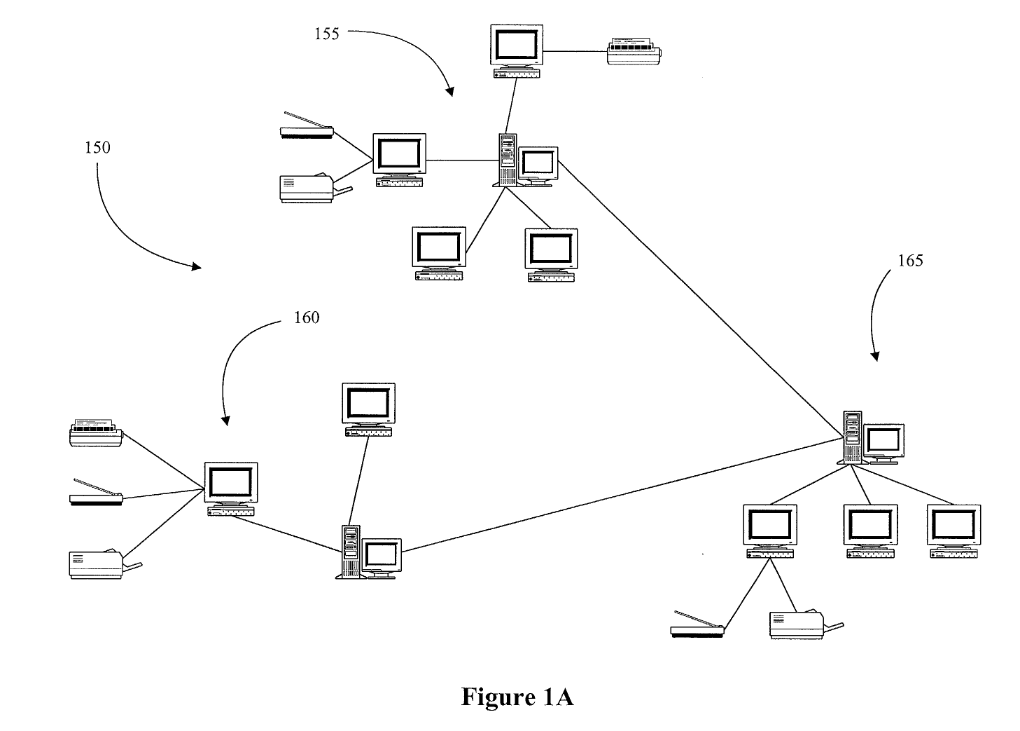

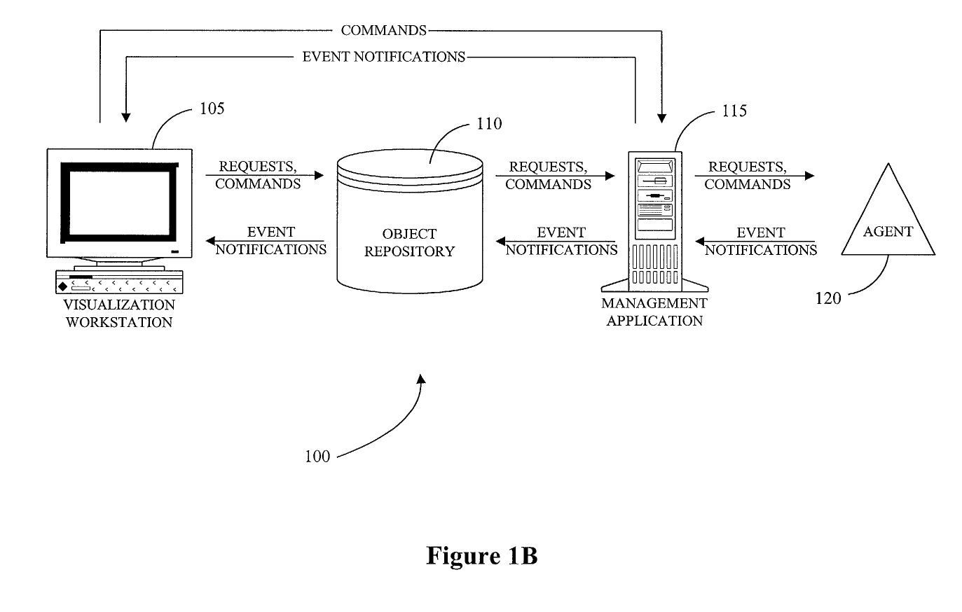

An exemplary IT enterprise is illustrated in FIG. 1A. The IT enterprise 150 includes local area networks 155, 160 and 165. IT enterprise 150 further includes a variety of hardware and software components, such as workstations, printers, scanners, routers, operating systems, applications, and application platforms, for example. Each component of IT enterprise 150 may be monitored and managed in accordance with the present disclosure.

The various components of an exemplary management system 100 topology that can manage an IT enterprise in accordance with the present disclosure are shown in FIG. 1B. The management system 100 includes at least one visualization workstation 105, an object repository 110, one or more management applications 115, and one or more management agents 120 associated with each management application 115.

The visualization workstation 105 provides a user access to various applications including a network management application 115. Workstation 105 interacts with an object repository 110 which stores and delivers requests, commands and event notifications. Workstation 105 requests information from object repository 110, sends commands to the object repository, and gets notification of events, such as status changes or object additions from it. The object repository 110 receives request information from the management application 115, which is fed by the management agents 120 responsible for monitoring and managing certain components or systems in an IT enterprise.

The management application 115 maintains object repository 110, in part, to keep track of the objects under consideration. The object repository 110 may be a persistent store to hold information about managed components or systems, such as a database. In an alternative embodiment, the management application 115 and object repository 110 may be integrated into a single unit that can hold information about managed components in volatile memory and perform the tasks of the management application.

As shown, one architectural aspect of the present system is that in normal operation, the visualization workstation 105 interacts primarily with the object repository 110. This reduces network traffic, improves the performance of graphical rendering at the workstation, and reduces the need for interconnectivity between the visualization workstation 105 and a multitude of management applications 115, their subsystems and agents 120 existing in the IT enterprises. Of course, embodiments having other configurations of the illustrated components are contemplated, including a stand-alone embodiment in which the components comprise an integrated workstation.

In addition to handling requests, commands and notifications, object repository 110 may also handle objects describing the structure and operation of the management system 100. Such objects may describe the momentary state, load, and performance of the components and/or systems. Such objects may be populated using a manual process or an automatic discovery utility.

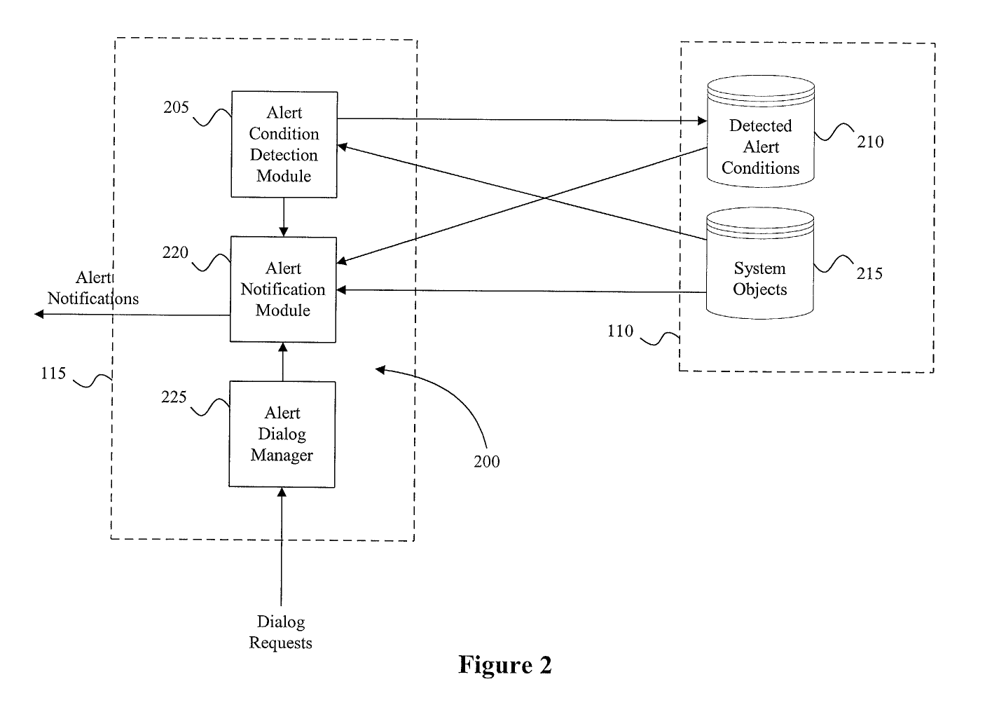

Referring now to FIG. 2, components forming one embodiment of an alert system according to the present disclosure are shown. Management application 115 includes an alert system 200 for detecting and reporting alert conditions pertaining to managed components of the IT enterprise 150. The alert system 200 includes alert condition detection module 205 which oversees the status of system components by analyzing database 215, containing system objects that define the topology of the system. Through analysis of the system objects of database 215, alert condition detection module 205 may identify an actual or potential alert condition. Upon identifying an alert condition, module 205 generates an alert condition object and stores it in database 210. Alert notification module 220 periodically analyzes the alert condition objects of database 210, and reports relevant alert conditions represented by the objects.

Alert system 200 also includes an alert dialog manager 225 for generating messages that describe a context of a system object that is the subject of a reported alert condition of the managed system. In one embodiment, the context description may be provided as a result of one or more dialog requests received by alert dialog manager 225 from an operator, as illustrated by FIG. 2. In an alternative embodiment, the alert notification module 220 and alert dialog manager 225 may be integrated, and the context description may be provided concurrently with an alert notification.

The context description of system object subject to an alert condition may include the physical location of the associated system component, the logical relationship of the system object to other system objects, the operating status of the system object, the business process(es) associated with the system object, the interest/business groups associated with the system object.

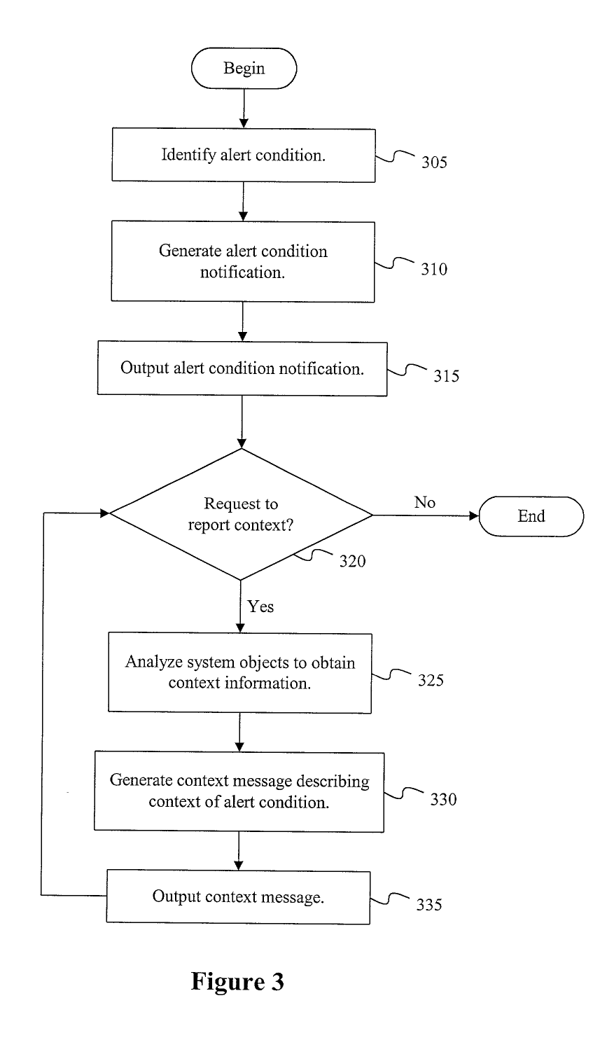

Referring now to FIG. 3, there is illustrated an exemplary flow diagram of methodology for reporting the context associated with an alert condition in accordance with one embodiment of the present disclosure. At block 305, an alert condition is detected. The alert condition may be an existing condition that requires operator attention, a warning regarding an existing condition or a predicted/potential condition that may require operator attention. Any technique known to those of skill in the art may be used in the detection of actual or potential alert conditions.

At block 310, an alert condition notification is generated. The notification may be embodied as text, motion video, audio or any other means for providing an alert. The alert condition notification may include an identification of the alert condition and/or a component of the system that is the subject of the alert. The alert condition notification is output to an operator at block 315.

At block 320, a determination is made whether a request to provide a description of the context of the alert has been received. If such a request has been received, the system continues processing at block 325. In an alternate embodiment, the system may be configured to automatically provide a complete or partial description of the context of the alert condition automatically, without requiring a request from an operator. In yet another alternate embodiment, the system may be configured to provide certain context information automatically, and certain other context information at the request of an operator.

At block 325, relevant system objects are analyzed to obtain context information. Which system objects that may be analyzed depend, in part, on the context information sought. For example, in order to provide the status of the component that is the subject of the alert condition, the system might analyze only the system object that represents the subject component. On the other hand, if the context request pertains to other components, such as for example, a request to list all components whose operation depend on the subject component, some or all of the system objects may be analyzed to determine their dependence on the subject component.

At block 330, a context message is generated describing the context of the alert condition and/or the subject component. The context message is output at block 335.

In the illustrated embodiment, blocks 320 through 335 may be performed more than once, allowing an operator to engage the system in a dialog. As an example, the system may output an alert notification at block 315 such as “There is a very high risk of a catastrophic slowdown in server uschdb02.”

As in the present example, certain information may be replaced or rephrased before the alert notification is output. Such replacement of terms, which may also be applied to messages describing the context of the alert condition, may be performed in order to make such a message more natural and easier to understand by a human operator. In the present example, the system has replaced numeric quantifiers such as “75% risk” and “severity 4” with non-numeric quantifiers like “very high risk” and “catastrophic slowdown.”

Contextual Description of the Managed Object

In order to identify the source of the problem, a user might request “what system is that?” seeking a more detailed contextual description of the managed component that is the subject of the alert notification. At block 335, the system may respond:

“uschdb02 is a mission-critical NT server in the Chicago web site server farm. It runs SQLServer. It has a replication server with automatic failover named uschdb02B, and this server is operational and in normal status.”

Such a response identifies the context of the managed component in terms meaningful to the user. Elements of the message include:

uschdb02: The alert dialog manager 225 identifies the managed component in the sentence, to ensure that there is no misunderstanding and to make the sentence self-descriptive.

Mission-critical: Database 215 maintains data describing the structure of the managed systems include an importance property for every object. The importance property may be defined at a class level or instance level, and may be propagated like status. The importance property is described in greater detail in the related commonly owned, co-pending, concurrently filed U.S. Patent Application entitled “Method and Apparatus for Filtering Messages Based on Context”

NT server: Identifies the class of the relevant component.

Chicago web site server farm: Identifies a grouping to which the relevant component belongs, which is discussed in greater detail below.

It runs SQLServer: This phrase identifies significant components contained in the managed component, in this example, a software system that runs on this server. In some cases, the function of a component may be carried out by a sub-component or subsystem hosted by the component. Since a component may host a number of sub-components and/or subsystems, in one embodiment only sub-components and/or subsystems having a threshold importance property may be reported to avoid/reduce confusion.

The final portion of the exemplary response, “it has a replication server with automatic failover named uschdb02B, and this server is operational and in normal status”, provides other information about the managed object, that may be of interest to the operator. In this example, the system has information about a replication and failover configuration installed for the object, and describes it, with a reasonable amount of descriptive information about the replication server. The alert dialog manager 225 also provides the name and current status of the replication server.

Identify the Topological Location of the Managed Object

In order to identify the source of the problem, a user might request “where is the component located?” seeking a more detailed contextual description of the physical component that is the subject of the alert notification. At block 335, the system may respond: “uschdb02 is in Chicago, in the Headquarters building, in subnet xyz, in segment 1234.”

The alert dialog manager 225 uses information about the location of the component in database 215 to determine the topological hierarchy related to the component, and creates a description based on a navigation down from the root of the hierarchy to the component. In the present example, the system may respond: “uschdb02 is in Chicago, in HQ, in subnet xyz, in segment 1234.”

Traffic Load Description

Other information that an operator might wish to know to address an error condition includes a traffic load description. The operator may request “How busy is the component?”, and the system might respond, for example, with “the traffic load on uschdb02 is high but within normal operating range.” Such a response illustrates how answers may be self-descriptive, to reduce the risk of misunderstandings over referents of pronouns.

Dependency Description

In order to address some alert conditions, an operator may wish to identify dependency relationships between the component that is the subject of the alert condition and other components within the system. In order to facilitate providing such information, the alert dialog manager 225 supports dependency queries such as “Who or what is dependent on the component?”

In response to the request for information, alert dialog manager 225 may reference database 215 at block 325 to analyze any dependency relationships associated with the subject component. The information regarding dependency relationships may be propagated up through a containment hierarchy. The alert dialog module 225 may generate and output a response, such as “All the web servers in the Chicago web site server farm are dependent on uschdb02.”, for example,

The dependency relationships may be explicitly defined by a user or an application or they are deduced from discovered relationships. The dependency relationships may also be propagated to other components. For example, if an application depends on a database platform, a machine hosting the application also depends on the database platform.

In one embodiment, to make the context message more meaningful, the alert dialog manager 225 may avoid a long list of components in the initial message. Instead, at block 325, the alert dialog module 225 may identify a natural grouping of the components that can be used to generate a more meaningful description. For example, components may be identified as belonging to a pre-defined grouping with a distinct label. If database 215 already defines the dependency relationship as pointing to a group, the alert dialog module 225 can readily create such a group-level description. If it does not, and the dependency relationships point to a number of components, the alert dialog module 225 can search for a natural grouping by listing all the groups that the components are members in, and analyzing the listing based on common definitions.

Examples of context messages resulting from such an analysis may include:

1) If there is a perfect match of the list of components with a group: “All the servers in the Chicago web site . . . ”

2) If some of the components in the list form a perfect match with a group: “All the servers in the Chicago web site plus the Detroit warehouse server . . . ”

3) If the components in the list match a group definition almost exactly: “All the servers in the Chicago web site except the SNA server . . . ”

4) If the components in the list form an imperfect match with a group: “Most of the servers in the Chicago web site . . .” or “Many of the servers in the Chicago web site . . . ”

In one embodiment, the alert dialog module 225 compares available group definitions, and selects one with the best match as the basis for the description. If no useful grouping matches the list, the system may enumerate the systems individually if the list is short, or may neglect to specifically identify a specific dependency by using a phrase such as “several systems”. To assist in the selection of a suitable grouping as the basis for a description, database 215 may include one or more indicators of the significance of different types of groupings. For example, membership in a business process such as Order Processing may be identified as more interesting, and therefore more useful as a descriptor, than the fact that servers are contained in a single network segment. Further, the alert dialog module 225 may support a request to explicit enumeration of dependencies, such as “the Chicago web site server farm includes uschap01, uschap02, uschap03, uschap05, uschap11, and uschap12”.

In addition, the user may issue a query about the status of an entire group. In response to such a query, the system may generate a response that refers to the entire group, instead of listing each of the objects in the group. The following dialog illustrates such a group based status request:

“All the web servers in the Chicago web site server farm are dependent on uschdb02.”

“What are their status?”

“The Chicago web site server farm is in normal status.”

Selection of Relevant Information

The analysis to obtain context information 325 is not limited to the objects of database 215. In some embodiments, alert dialog module 225 may utilize other information stores to obtain context information regarding the managed object. When an abundance of context information is obtained, it may be advantageous to present only a portion of the available information so as not to impair understanding of the large-scale situation. Accordingly, alert dialog module 225 may include control logic to determine which pieces of information to present. In one embodiment, alert dialog module 225 ranks each piece of information based on the importance ranking of each object, as well as predefined rules regarding what types of information are most interesting. These rules may be dependent on factors such as, for example, a component being managed or an operator identifier.

For example, when managing some networked computer systems, it may be more interesting to know what business process the system is a part of, rather than what network subnet it is a part of. The alert dialog module 225 may create the descriptive elements, and then rank them by relevance, including only the most important ones.

Impact Analysis

In some embodiments, the object repository 110 stores data describing relationships among managed components, including, for example, containment relationships indicating which components are contained in another and various types of dependency relationships. Accordingly, the system may perform an impact analysis, which may be used to generate messages regarding all components affected by a diagnosed or predicted alert condition.

In one embodiment, the most important effects or problems may be reported to an operator. The management application 115 may employ logic to identify an impact analysis chain and create the alert notifications based on the most important object that is affected. Since the importance property propagates along containment and dependency relationships, this is likely the highest object in the containment hierarchy.

Language Translation

It is recognized that in a multinational system, operators may speak different native languages. Accordingly, in one embodiment the alert notification system includes translation capabilities.

Language translation may be performed in at least two ways: (1) a message may be generated in several languages, and one of the several languages may be selected for output to an operator, or (2) a message may be generated in some suitable language and translated in real time to another language for output to an operator.

Since complex systems may generate a wide variety of messages, messages that are constructed by intelligent subsystems in the form of complete sentences with context-dependent elements, it may not be practical to address translation of messages simply by manually translating the messages beforehand. Further, because the individual subsystems may be written in different countries and may run in different countries, it may not be realistic to enforce that all messages be generated in English. Therefore, according to one embodiment, the alert subsystem of management application 115 may generate messages in a predetermined language based on each subsystem, and the messages may be translated by industry-standard translation software.

This application is further related to U.S. Pat. Nos. 5,958,012, 6,289,380 and 6,327,550, and co-pending U.S. applications Ser. Nos. 09/558,897, and 09/559,237, which are all incorporated in their entirety herein by reference.

Accordingly, it is to be understood that the drawings and description in this disclosure are proffered to facilitate comprehension of the system, and should not be construed to limit the scope thereof. It should be understood that various changes, substitutions and alterations can be made without departing from the spirit and scope of the system.

What is claimed is:

1. A method for reporting the context of an alert condition, comprising:
reporting an alert condition associated with a subject system object;
analyzing one or more system objects associated with the alert condition to obtain context data;
generating a context message based on the context data; and
outputting the context message.

2. The method of claim 1, further including receiving a request to report the context of the alert condition.

3. The method of claim 1, wherein the analyzing includes determining properties of the subject system object.

4. The method of claim 1, wherein analyzing includes determining a physical location of a component represented by the subject system object.

5. The method of claim 1, wherein analyzing includes determining a logical relationship of a component represented by the subject system object to at least one other component.

6. The method of claim 1, wherein analyzing includes determining a traffic load associated with the subject system object.

7. The method of claim 1, wherein analyzing includes identifying one or more system objects, each identified system object representing a components that is dependent on a component represented by the subject system object.

8. The method of claim 1, wherein generating includes replacing quantifiable context data with a qualitative identifier.

9. A system for reporting the context of an alert condition, comprising:
means for reporting an alert condition associated with a subject system object;
means for analyzing one or more system objects associated with the alert condition to obtain context data;
means for generating a context message based on the context data; and
means for outputting the context message.

10. A computer-readable storage medium encoded with processing instructions for reporting the context of an alert condition, including:
computer readable instructions for reporting an alert condition associated with a subject system object;
computer readable instructions for analyzing one or more system objects associated with the alert condition to obtain context data;
computer readable instructions for generating a context message based on the context data; and
computer readable instructions for outputting the context message.
